(19) United States
(12) Patent Application Publication
(10) Pub. No.: US 2007/0074676 A1
(43) Pub. Date: Apr. 5, 2007

(54) Reversible pet collar and leash

(76) Inventor: Matthew Cole Van Sickle, Washington, DC (US)

Correspondence Address: Matthew Van Sickle, 1401 Columbia Rd. NW #404, Washington, DC, 20009, US

(21) Appl. No.: 11/541,940

(22) Filed: Oct. 2, 2006

Related U.S. Application Data
(60) Provisional application No. 60/722,396, filed on Oct. 1, 2005.

(51) Int. Cl. A01K 27/00

(52) U.S. Cl. 119/795

(57) ABSTRACT

A pet collar and pet leash that utilize two novel fastening systems/devices, one located on the pet collar and one located on the pet leash, which allow the leash to attach to either side of the collar, and also enabling both the collar and the leash to be easily and completely reversible. Additionally the novel fastening system/device located on the pet leash creates a reversible handle for the leash and also allows for the leash to be secured around certain stationary objects, such as parking meters, while not affecting its reversible properties.

### CROSS-REFERENCE TO RELATED APPLICATIONS:

This application claims the benefit of U.S. Provisional Patent Application Ser. No. US/60,722,396, filed on Oct. 1, 2005.

### BACKGROUND OF THE INVENTION

The present invention is directed toward a reversible pet leash restraint system/device. The present invention is comprised of two parts, a collar and a leash, which utilize a novel fastening system/device to allow them to be reversible while maintaining ease of use and performance.

There are many patents related to dog restraint systems, including the following: U.S. Pat. Nos. 5,839,394; 5,915,336; 6,082,308; 5,842,444; 5,950,569 ; and, 6,553,944.

While all of the aforementioned prior art constructions are more than adequate for the basic purpose and function for which they have been specifically designed, they fail to provide a construction which allows both the collar and the leash to be easily reversible, and thus providing two designs in one, while maintaining ease of use and optimum control of the pet.

As a consequence of the growing fashion and style needs that pet owners are desiring for their pets, it is important that an effective means be created to incorporate a reversible aspect into both collars and leashes, without minimizing the performance or function of either.

### BRIEF SUMMARY OF THE INVENTION

Briefly stated, the present invention generally relates to the field of pet collar and leash construction, and more particularly, to a collar and leash restraint system that is entirely reversible.

The present invention comprises a collar unit and a leash unit that utilize a novel fastening system/device, which allow the leash to attach to easily attach to either side of the collar, while maintaining optimum performance of the leash

Additionally, the same novel fastening system/device on the leash creates a benefit in addition to making it reversible; namely, that the leash can be secured around certain stationary objects, such as parking meters.

### BRIEF DESCRIPTION OF THE SEVERAL VIEWS OF THE DRAWING

These and the other attributes of the present invention will become more clear upon a thorough study of the following description of the preferred embodiment for carrying out the invention, particularly when reviewed in conjunction with the drawings, wherein:

FIG. 1 is a top view of the reversible collar;

FIG. 2 is a back view of the reversible collar;

FIG. 3 is a top view of an embodiment version of the reversible collar;

FIG. 4 is a back view of an embodiment version of the reversible collar;

FIG. 5 is a top view of the reversible leash;

FIG. 6 is a back view of the reversible leash;

FIG. 7 is a top view of an alternate embodiment of the reversible leash; and,

FIG. 8 is a back view of an alternate embodiment of the reversible leash.

### DETAILED DESCRIPTION OF THE INVENTION

With respect to the drawings, the present invention is based on the provision of the following structural elements:
a. A pet collar with a novel fastening system/device and a “twist and pull” or other “reversible” buckle and,
b. A pet leash with the same novel fastening system/device and two standard metal leash clips, located at opposite ends.

With respect to FIG. 1, a truncated top view of the collar element 9 with one pattern is shown comprising a “twist and pull” buckle 1 attached at 2 to the main body of the leather collar, with an extra loop of leather 3 to secure the loose “tail” of the leather, a novel fastening system/device 4, 5, 6, and 7, where one side of the novel fastening system/device is comprised of a small metal d-ring 4 that secured with an additional piece of leather 5 and two rivets 6, and holes 8 are used to secure the leather collar element 9 though the buckle 1

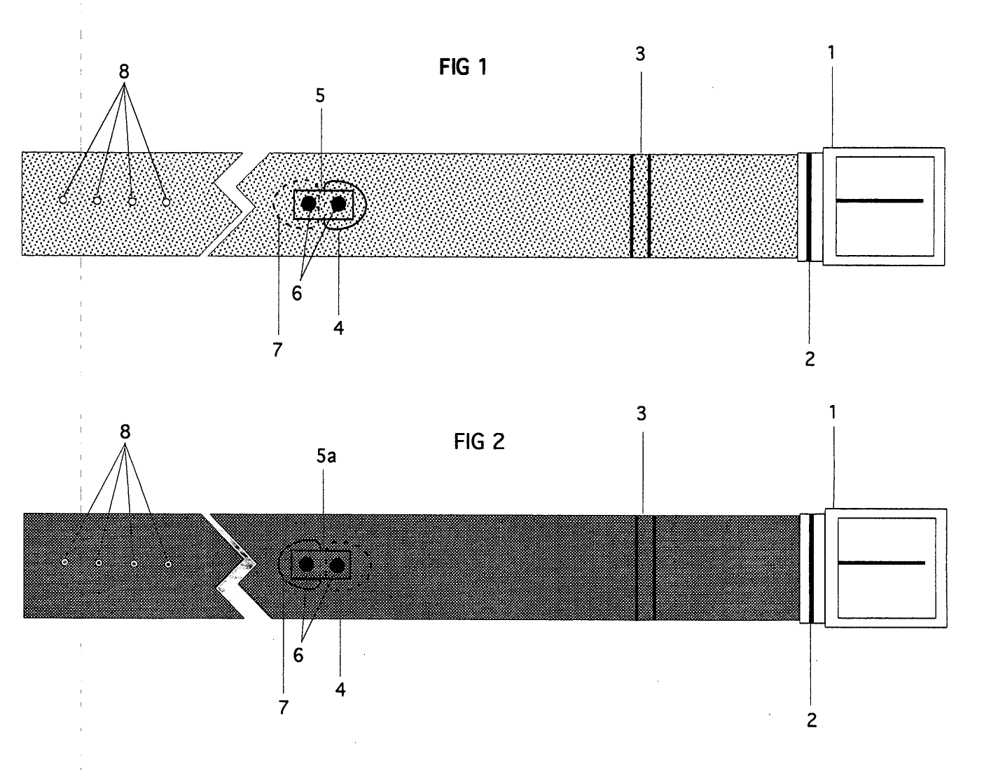

With respect to FIG. 2, the truncated back view of the collar element 9 is shown with a different pattern, where the buckle 1 has been turned to its second position, and where the novel fastening system/device is completed with a second metal d-ring 7 similarly attached as in FIG. 1 by means of additional piece of leather 5a and the same rivets 6 as in FIG. 1.

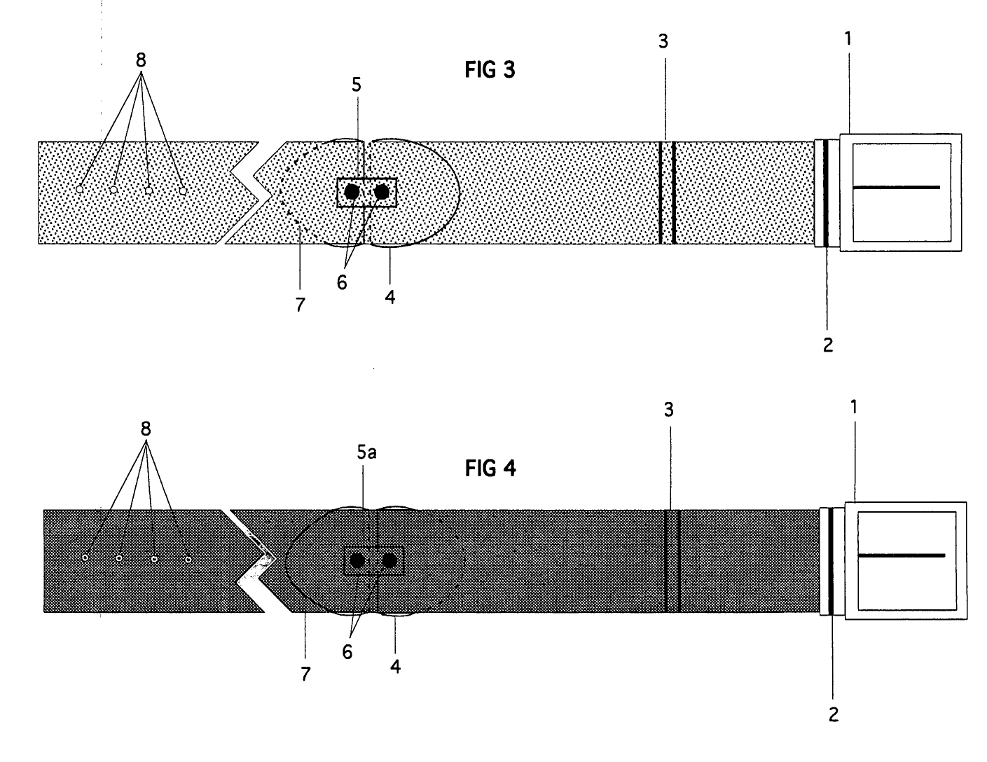

FIGS. 3 and 4 represent a truncated alternate embodiment of the collar element 9 of the present invention where the novel fastening system/device has been altered, utilizing larger d-rings 4a and 7a, such that the flat portion of the d-ring is secured around the entire collar element 9 and held in place on the opposite side of the collar element 9 from which they will be accessed, secured with a similar piece of leather 5 and 5a and fastened with rivets 6.

With respect to FIG. 5, a truncated top view of the leash element 15 is shown where a standard metal leash clip 10 is located on one end and may be attached to metal d-ring 11, attached in the same manner as in FIGS. 1 and 2 (through an additional piece of leather 12 and fastened with rivets 13), to form the handle of the leash or to create a means for securing the this end of the leash around certain stationary objects, such as parking meters.

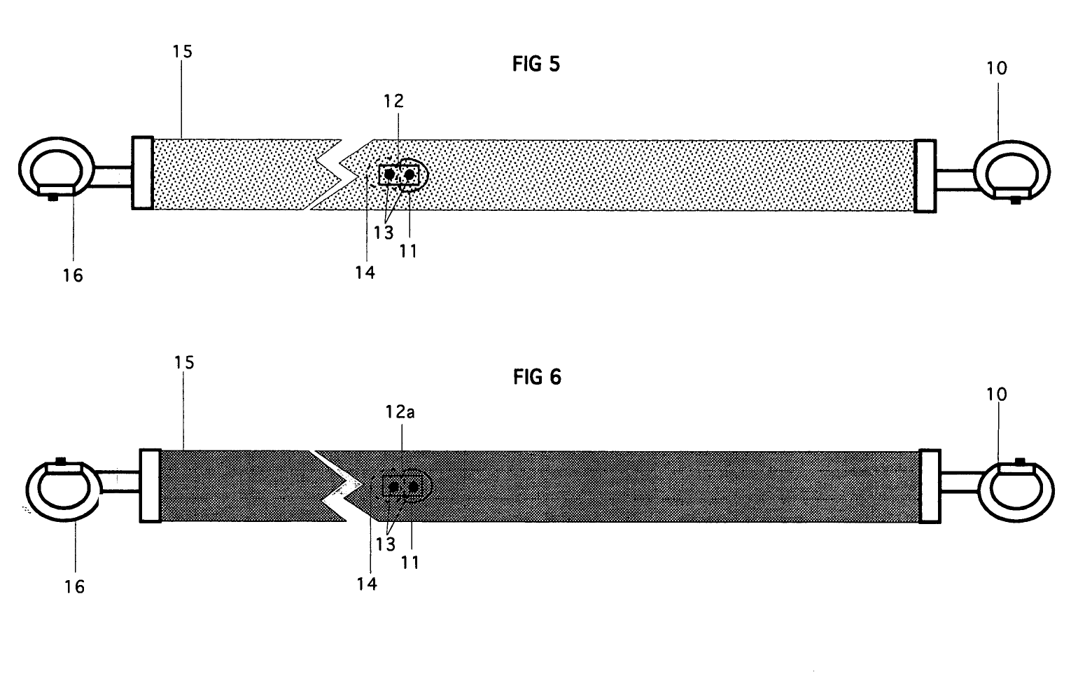

With respect to FIG. 6, a truncated back view of the leash element 15 is shown where the same standard metal leash clip 10 may be attached to a second d-ring 14, attached in the same manner as in FIGS. 1 and 2 through an additional piece of leather 12a and fastened with rivets 13, forming the same handle or means of attachment as described above.

With respect to FIGS. 5 and 6, a second standard metal leash clip 16 is used to attach to d-rings 4 and 7 in FIGS. 1 and 2 as means of securing the leash to the collar.

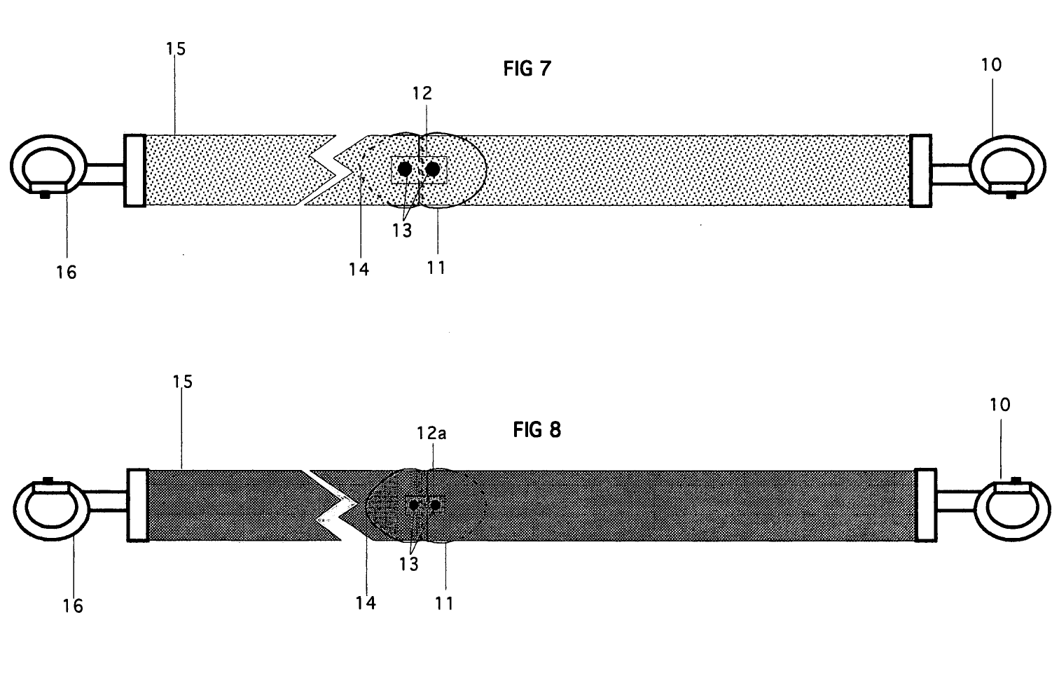

FIGS. 7 and 8 represent a truncated alternate embodiment of the leash element 15 of the present invention where the novel fastening system/device has been altered, utilizing larger d-rings 11a and 14a, such that the flat portion of the d-ring is secured around the entire leash element 15 and held in place on the opposite side of the leash element 15 from which they will be accessed with a similar piece of leather 12 and 12a and fastened with rivets 13.

When the collar element 9 and the leash element 15 are used in conjunction, a user can attach the standard metal leash clip 15 to either d-ring 4 or d-ring 7 allowing both side of the collar to be used effectively, and creating the ability differing patterns on the opposite sides of the collar.

When the standard metal leash clip 10 is secured to either d-ring 11 or 14 a loop is formed that can used as a handle for the leash, or as a means of securing the leash to certain stationary objects, such as parking meters, while allowing the user to similarly choose between two different patterns which will be on opposite sides of the leash unit

These drawings represent only a few of the many variations of the present invention but serve to demonstrate it unique characteristics. Those skilled in the art will readily appreciate that many modifications are possible without materially departing from the novel teachings and advantages of this invention. Accordingly, aspects of the present invention have been described by way of example only and modification and addition thereto may be made without departing from the scope thereof as defined in the appended claims.

What is claimed herein is:

1. A pet collar comprising;
a standard pet collar body element
a “twist and pull” or other “reversible” buckle, and
a novel fastening system/device.

2. A pet collar in claim 1; wherein standard pet collar body element is comprised of leather or a synthetic material with similar properties and contains the standard holes needed to secure the one end of the collar through the buckle.

3. A pet collar as in claim 2; wherein the novel fastening system/device is located on the collar such that when the collar is situated on the pet with the buckle facing forward, the novel fastening system/device will rest on the back of the neck of the pet, maximizing user control.

4. A pet collar as in claim 3; wherein the novel fastening system/device is comprised of two metal d-rings mounted on opposite sides of the collar by means of two small pieces of leather or similar material and two rivets or similar fasteners.

5. A pet collar as in claim 4; wherein the d-rings are mounted around the entire body of the collar element and secured in place on the opposite side of the collar body element from which they will be accessed by means of a two small pieces of leather or similar material and two rivets or similar fasteners.

6. A pet collar as in claim 5; wherein the d-rings are mounted through the body of the collar element and secured in place by means of rivets or similar fasteners on either side of said d-rings.

7. A pet collar as in claim 6; wherein an additional loop of leather or similar material is provided to secure the additional leather “tail” once the end of the collar is secured to the buckle.

8. A pet leash comprising:
a standard pet leash body element
two standard metal leash clips, and
a novel fastening system/device.

9. A pet leash as in claim 8; wherein the standard pet leash body element is comprised of leather or a synthetic material with similar properties.

10. A pet leash as in claim 9; wherein the two standard metal leash clips are located on opposite ends of the pet leash body element.

11. A pet leash as in claim 10; wherein the novel fastening system/device is located approximately 15 inches from one end of the leash.

12. A pet leash as in claim 11; where in the novel fastening system/device is comprised of two metal d-rings mounted on opposite sides of the leash by means of two small pieces of leather or similar material and two rivets or similar fasteners.

13. A pet leash as in claim 19; wherein the d-rings are mounted around the entire body of the leash element and secured in place on the opposite side of the leash body element from which they will be accessed by means of a two small pieces of leather or similar material and two rivets or similar fasteners.

14. A pet leash as in claim 13; wherein the d-rings are mounted through the body of the leash element and secured in place by means of rivets or similar fasteners on either side of the d-rings.
